(19) United States
(12) Patent Application Publication
(10) Pub. No.: US 2015/0026083 A1
(43) Pub. Date: Jan. 22, 2015

(54) Generating Connection Map for Intelligent Connections in Enterprises

(71) Applicant: InsideView Technologies, Inc., San Francisco, CA (US)

(72) Inventors: Abhay Kumar Paliwal, Hyderabad (IN); Jason Muldoon, San Francisco, CA (US)

(21) Appl. No.: 14/332,253

(22) Filed: Jul. 15, 2014

Related U.S. Application Data
(60) Provisional application No. 61/847,611, filed on Jul. 18, 2013.

(51) Int. Cl. G06Q 50/00; G06Q 10/00

(52) U.S. Cl. CPC G06Q 50/01; G06Q 10/00
USPC 705/319

(57) ABSTRACT

A user establishes a profile with an enterprise intelligence system. The user specifies a watchlist identifying entities such as members and/or enterprises in which the user is interested. The user also specifies recommendation criteria specifying the types of recommenders to use to identify connections with the entities. The recommenders are used to identify attributes in common between the user and members, and to generate a connection map describing social connections between the user and the members based on the common attributes. A recommendation model for the user generates decision aiding information. The connection map is organized and presented to the user based on the generated decision aiding information. User interactions with the connection map are observed and the recommendation model is updated based on the observed interactions. A pattern of recommenders preferred by the user is learned from the observed interactions, and is used to guide future decision making.

### CROSS-REFERENCE TO RELATED APPLICATION

This application claims the benefit of U.S. Provisional Patent Application No. 61/847,611, filed Jul. 18, 2013.

### BACKGROUND

1. Field of Art

The present invention generally relates to the field of relationship management, and more specifically to managing and organizing a user's connections with members of enterprises.

2. Description of the Related Art

A person may wish to gain insight about a company or other enterprise for a variety of reasons. For example, a salesperson may wish to understand the organizational structure of an enterprise in order to efficiently deliver information or services to the enterprise. In addition, the person may wish to know how she is connected to members of the enterprise.

Social networks provide one way to obtain this information. A social network can identify members of an enterprise connected with a person. Thus it may be possible for a salesperson to use a social network to identify members of the enterprise with whom the salesperson is connected.

However, existing tools do not provide relevant information about the quality of the connections. The person might have a large number of connections to members of the enterprise. In addition, the members of the enterprise are likely to be connected with a large number of other members. Thus, the person might actually be connected to a majority of the members of the enterprise once multiple degrees of connections are considered.

The large amount of connections to members of the enterprise makes it difficult to determine which members are most relevant to the person's particular needs and goals. Existing tools might provide the person with a list of all members of the enterprise with whom the person is connected, but the list may include members with no interest or relevance to the person's goals. As a result, it is difficult for the person to obtain useful information using current tools.

### BRIEF SUMMARY

The above and other issues are addressed by a method and computer system for generating a connection map for a user. An embodiment of the method comprises receiving a plurality of attributes of the user and collecting content about a plurality of members of an enterprise from a plurality of content sources. The content specifies a plurality of attributes of the plurality of members of the enterprise. The method further comprises generating a plurality of social connections between the user and the plurality of members of the enterprise. The plurality of social connections are based on at least one common attribute between the user and the plurality of members of the enterprise. The method additionally comprises generating decision aiding information responsive to at least one recommendation criterion preferred by the user in association with the at least one common attribute and observing a plurality of interactions between the user and the generated connection map to learn at least one recommendation criterion preferred by the user in a time period. The method also comprises and utilizing the at least one learned recommendation criterion to update the connection map.

An embodiment of the system comprises a computer processor for executing computer program modules and a non-transitory computer-readable storage medium for storing computer program modules. The modules are executable to perform steps comprising receiving a plurality of attributes of the user and collecting content about a plurality of members of an enterprise from a plurality of content sources. The content specifies a plurality of attributes of the plurality of members of the enterprise. The steps further comprise generating a plurality of social connections between the user and the plurality of members of the enterprise. The plurality of social connections are based on at least one common attribute between the user and the plurality of members of the enterprise. The steps also comprise generating decision aiding information responsive to at least one recommendation criterion preferred by the user in association with the at least one common attribute. In addition, the steps comprise observing a plurality of interactions between the user and the generated connection map to learn at least one recommendation criterion preferred by the user in a time period and utilizing the at least one learned recommendation criterion to update the connection map.

The above and other issues are also addressed by a non-transitory computer readable medium storing executable computer program code for predicting a probable social connection for a user. The computer program code is executable to perform steps comprising receiving at least one query from the user regarding at least one member of an enterprise. The steps further comprise receiving at least one preferred recommendation criterion from the user in a time period and generating a connection map indicating a plurality of social connections between the user and the at least one member of the enterprise. The plurality of social connections comprise a plurality of first degree connections and a plurality of second degree connections wherein the plurality of first degree connections and the plurality of second degree connections are determined responsive to the at least one preferred recommendation criterion. The steps additionally comprise learning a pattern of the at least one preferred recommendation criterion generated by the user in the time period and utilizing the learned pattern of the at least one preferred recommendation criterion to predict the probable social connection of the user with the member of the enterprise.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 illustrates a computing environment in which an enterprise intelligence system provides information about members of enterprises, according to one embodiment.

FIG. 2A is a block diagram illustrating a more detailed view of the enterprise intelligence system of FIG. 1, according to one embodiment.

FIG. 2B is a block diagram illustrating a more detailed view of the connection mapping module of FIG. 2A, according to one embodiment.

FIG. 3 illustrates a graphical user interface showing a connection map generated by a recommendation presentation module of the enterprise intelligence system, according to one embodiment.

FIG. 4 is a flowchart illustrating steps performed by the enterprise intelligence system, according to one embodiment.

FIG. 5 is a high-level block diagram illustrating physical components of a computer used by one or more of the entities illustrated in FIG. 1, according to one embodiment.

The figures depict embodiments of the present invention for purposes of illustration only. One skilled in the art will readily recognize from the following description that alternative embodiments of the structures and methods illustrated herein may be employed without departing from the principles of the disclosure described herein.

### DETAILED DESCRIPTION

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality. In addition, where there may be one or more of an illustrated entity, the figures and specification may use a single reference number to refer to both the singular and plural instance of the entity.

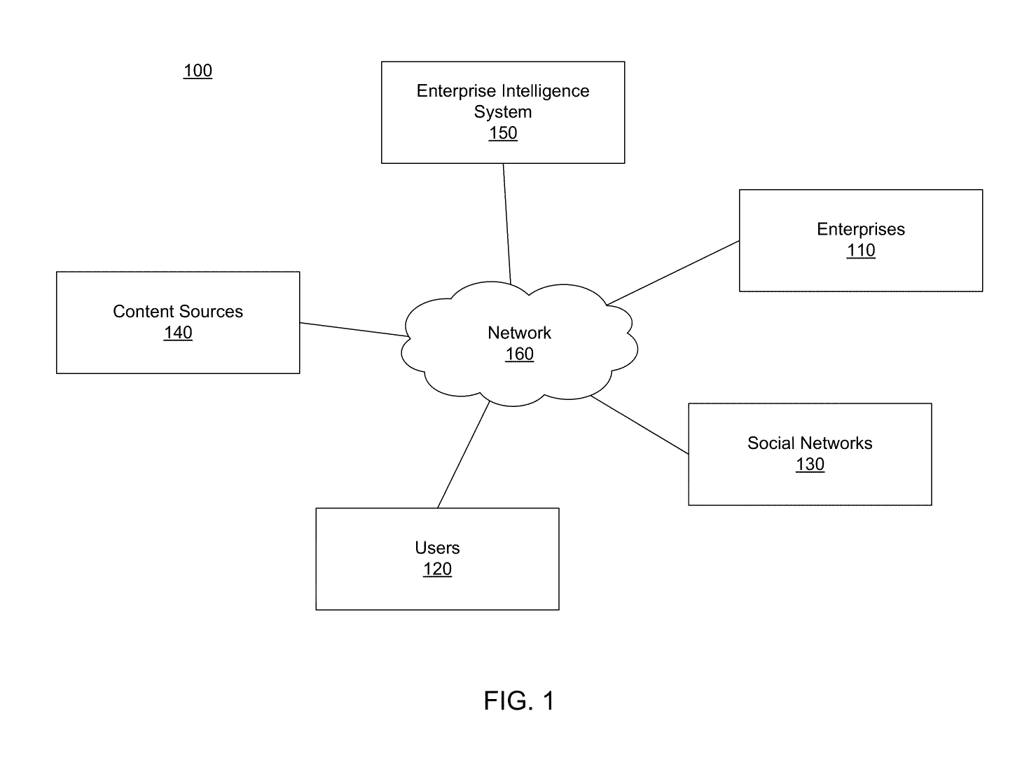

FIG. 1 illustrates a computing environment 100 in which an enterprise intelligence system 150 provides information about members of enterprises, according to one embodiment. The computing environment 100 also includes enterprises 110, users 120, social networks 130, and content sources 140, communicatively coupled to the enterprise intelligence system 150 by a network 160. Other embodiments may include different and/or additional entities.

The network 160 enables communications among the other entities illustrated in FIG. 1. The network 160 may use standard or custom communications technologies and/or protocols and, in one embodiment, is the Internet.

The enterprises 110 represent one or more target communities of interest to users of the enterprise intelligence system 150. Generally, an enterprise is a business, educational, or governmental organization. For example, an enterprise may be a private or public company, a university, or a government agency. An enterprise may also be a professional group, a social group, a personal group, a friends group and the like.

An enterprise 110 includes one or more members. The members are people that act on behalf the enterprise. For example, the members may include employees, owners, and advisors of a business. Different members may have different roles within the enterprise. Some members of an enterprise may be responsible for making strategic decisions while other members may be responsible for making purchasing decisions. Some members may have multiple roles within an enterprise, and some members may be associated with multiple enterprises.

The enterprises 110 may operate one or more computers that are connected to the network 160. These computers may provide information about the enterprises 110. For example, an enterprise 110 may operate a web site that provides information about the activities of the enterprise, the members of the enterprise, and the like. In addition, the computers operated by the enterprises 110 provide a facility for electronic communication with the members of the enterprises.

The users 120 are people who use the enterprise intelligence system 150 to learn about members of enterprises 110. A user 120 may also be a member of an enterprise 110. As one example, a user 120 may be a salesperson who uses the enterprise intelligence system 150 to gain insight into the organizational structure of an enterprise 110 in order to identify a member of the enterprise responsible for purchasing decisions. The users 120 use one or more computers to interact with the enterprise intelligence system 150.

The social networks 130 store information about people in the computing environment 100, including information about the users 120 and members of the enterprises 110. The information stored by the social networks 130 may include profiles and social connections of the people. The stored profiles describe attributes of the people. For a given person, the profile may store information describing employment attributes such as the person's current job title and employer and the person's previous employment history. Likewise, the profile may store information describing educational attributes such as a person's educational background.

Social connections stored in the social networks 130 describe social relationships among the people in the computing environment 100. In addition, the social networks 130 may store social media messages made by people using the social networks 130. These messages may be directed to the public at large and/or to specific people. The messages may explicitly or implicitly describe interests or activities of the people in the social network. For example, a person who is involved in sales or marketing for an enterprise may post messages related to these topics. The social networks 130 may also store endorsements where one person recommends another person.

Depending upon the embodiment, there may be one or more social networks 130 in the environment 100. These social networks 130 use one or more computers to connect to the network 160 and exchange information. Users and members may belong to one or more of the social networks 130.

The content sources 140 provide information about the entities in the environment 110. For example, the content sources provide information about enterprises 110 and members of the enterprises, as well as information about other topics. There may be a variety of different content sources 140 providing a variety of different types of information. For example, a content source may be a news site, website, blog, social network site, professional network site and the like. A news content source 140 may provide news information describing current events involving the enterprises 110 and members. A business information content source 140 may provide information about specific enterprises 110. For example, a business information content source 140 may include a database that describes attributes of members of a specific enterprise 110, such as the members' titles and roles within the enterprise, and the members' employment and educational histories.

The content sources 140 may include public content sources such as web sites, blogs, and other sources that are publicly-accessible on the network 160. In addition, the content sources 140 may include private content sources such as databases that are available via paid access. The content sources 140 likewise include content that is published by the enterprises 110 and content published by other people or organizations.

The enterprise intelligence system 150 provides users 120 with information about the enterprises 110 and members of the enterprises. In one embodiment, the enterprise intelligence system 150 includes one or more computers that provide a web site or other interface using which the users 120 can interact with the system. The users 120 use the enterprise intelligence system 150 to learn information about members in different enterprises 110 that align with the user's goals. For example, a user who is a salesperson can use the enterprise intelligence system 150 to identify members of enterprises who might be interested in purchasing items from the user.

When a particular user uses the enterprise intelligence system 150 to gain information about a target community such as members of an enterprise 110, the user may specify one or more types of recommenders that the enterprise intelligence system 150 should use to ascertain connections between the user and the members. The enterprise intelligence system 150 accesses information from the enterprises 110, social networks 130 and content sources 140 and uses the information in combination with the specified recommenders to generate a connection map describing the relationships between the user 120 and the members of the enterprises 110. The relationships may be based on attributes in common among the user and the members.

In addition, the enterprise intelligence system 150 generates a set of recommendations from the connection map that ranks the connected-to members based on the user's goals, the strength of the connections, and/or other factors. The enterprise intelligence system 150 displays the connection map of the recommended members in the target community to the user. For example, the enterprise intelligence system 150 may identify a member of the enterprise that is highly-aligned with the user's interests, and display a connection map identifying this member as the “best” connection for the user, and showing the social connections that link the user to the member. The user may interact with the displayed connection map. The enterprise intelligence system 150 uses the feedback to improve the quality of subsequent recommendations to the user.

Thus, the user may use the recommendations to identify particular members within a target community that the user may contact in order to further the user's goals. For example, if the user is a salesperson, the enterprise intelligence system 150 may provide the user with a set of recommended members of a targeted enterprise with whom the user has social connections based on attributes in common and that the content sources indicate has purchasing authority for the enterprise.

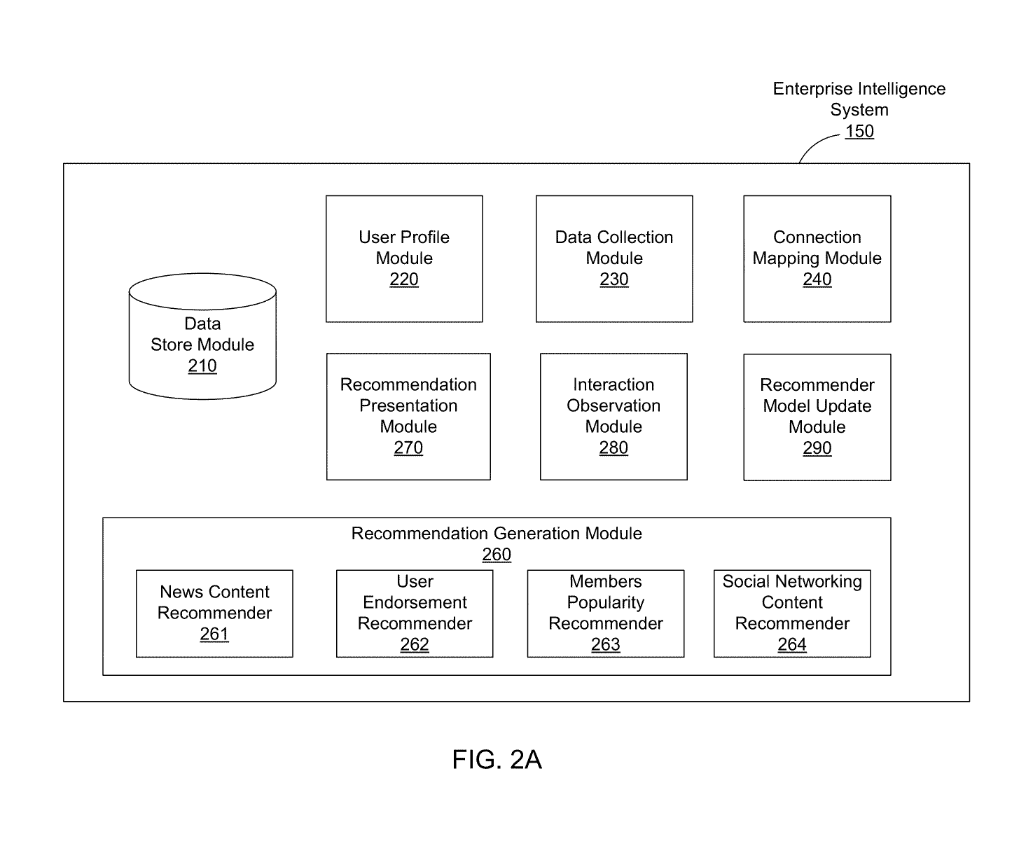

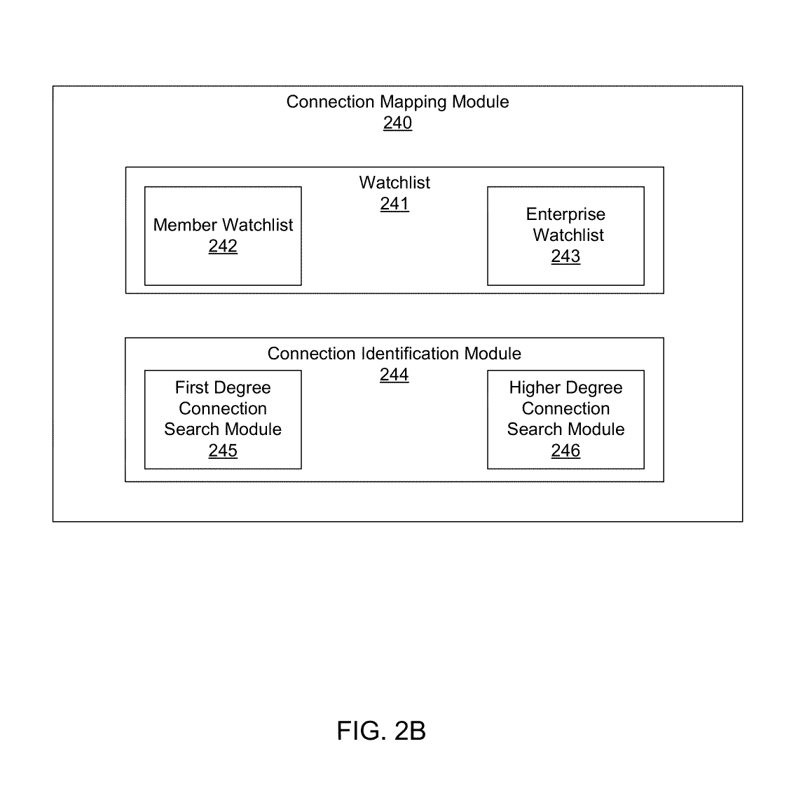

FIG. 2A is a block diagram illustrating a more detailed view of the enterprise intelligence system 150 according to one embodiment. In the embodiment shown, the enterprise intelligence system 150 contains a variety of different modules. Those of skill in the art will recognize that other embodiments of the enterprise intelligence system 150 can have different and/or additional modules other than the ones described here, and that the functions may be distributed among the modules in a different manner.

A data store module 210 stores data collected, generated, and used by the enterprise intelligence system 150. The data includes data collected from the social networks 130 and content sources 140, data provided by users of the enterprise intelligence system 150, and data generated by the system during processing of other data and interactions with the users. The data store module 210 may store additional and/or other data in various embodiments.

A user profile module 220 establishes profiles of users 120 with the enterprise intelligence system 150. In one embodiment, the user profile module 220 provides graphical user interfaces (GUIs) to users allowing the users to establish accounts at the enterprise intelligence system 150. As part of this process, the users 120 provide profile information describing themselves. A user's profile may identify, for example, the user's name, academic information, career information, personal information, social information, present co-worker information, past co-worker information, reference people information, alumni information and the like.

In one embodiment, the profile of a user 120 also contains links to the user's accounts on one or more of the social networks 130. For example, the user 120 may provide the user's login credentials for the social networks 130 to the user profile module 220 when establishing the user's account. The user profile module 220 may then use these credentials to access the user's accounts at the social networks 130 and retrieve information about the user and the user's social connections. The user profile module 220 stores the retrieved information within the user's profile.

A data collection module 230 collects information from the content sources 140, enterprises 110, and/or other sources. As mentioned above, this information may include information about the enterprises 110 and members of the enterprises. The attributes collected about members of enterprises may include academic information, career information, personal information, social information, present co-worker information, past co-worker information, reference people information, alumni information, and the like. The data collection module 230 stores the collected information in the data store module 210.

A connection mapping module 240 generates connection maps describing social connections between users 120 and members of enterprises 110. The connection mapping module 240 generates the connection maps using the user profile information established by the user profile module 220 and the information collected from the content sources 140 by the data collection module 230. In one embodiment, the connection mapping module 240 generates the connections by finding attributes in common between people (e.g., between users and members, and between members) For example, the connection mapping module 240 may generate a connection between two people who went to the same educational institution or who worked for a same previous employer.

The generated connection map describes a user's degrees of association with members in the connection map. The degree of association refers to the number of social connections needed to be traversed to connect the two people in a connection map. Thus, two people who have one or more similar attributes (e.g., attended the same social institution) have a first degree connection. A first person who is connected to a third person via an intermediate person has second degree with the third person. In this case, the first person shares one or more attributes with the intermediate person; the intermediate person, in turn, shares one or more attributes with the third person. Additional details regarding the connection mapping module 240 are described with reference to FIG. 2B.

A recommendation generation module 260 generates recommendations for members within the connection maps created by the connection mapping module 240. The recommendations indicate how strongly members within the connection map align with the user's goals as indicated at least in part by user-specified targeting criteria, with more aligned members being more highly recommended and a most highly-aligned member being designated as a “best” member. In one embodiment, the recommendations are presented as decision aiding information in the sense that the recommendations aid the user in identifying members to contact. The decision aiding information may take the form of rankings of members within a connection map, with more highly-recommended members receiving a correspondingly higher ranking. The decision aiding information may be organized within the respective degrees of connection, so that, e.g., second degree connections are compared against other second degree connections.

For example, if a user requests a connection map for a particular enterprise, the connection map may have only a few first degree members, many second degree members, and a large number of third degree members. The recommendation generation module 260 generates recommendations that organize the first degree members with respect to other first degree members, organize the second degree members against other second degree members, and organize the third degree members against other third degree members. Since there may be many members at each level of the hierarchy, the recommendations serve to identify those members that are particularly aligned with the user's targeting criteria.

The recommendation generation module 260 may use a variety of different criteria to produce the recommendations. In one embodiment, the recommendation generation module 260 includes multiple discrete modules called “recommenders” that each produce independent decision aiding information indicating strengths of recommendations of members. The decision aiding information produced by the recommenders may be numerical recommendation scores, semantic analysis of the news content, and/or sentiment analysis of social feeds content and the like indicating how well given members align with a user's targeting criteria.

A user may specify which of the recommenders the recommendation generation module 260 should use to produce a set of recommendations. In this way, the user specifies the criteria used by the recommendation generation module 260 to generate the recommendations for members within the user's connection map. The user may specify different recommenders for different degrees of connection within the connection map. For example, the user may specify a set of recommenders for first degree connections, and specify a different set of recommenders for second degree connections.

If the user specifies that the recommendation generation module 260 use multiple recommenders, the recommendation generation module 260 combines the decision aiding information from the specified recommenders to produce combined decision aiding information, and then provides recommendation using the combined information. For example, the members may be displayed in order of the combined scores.

The recommendation generation module 260 may apply different weights to different recommenders when producing the decision aiding information. The recommendation generation module 260 may, for instance, combine the decision aiding information received from the various recommenders according by applying the different weights associated with the different recommenders. In this way, the influence of particular recommenders can be increased or decreased by respectively increasing or decreasing the recommenders' weights. The set of recommender weights associated with a particular user forms a recommendation model for the user.

In one embodiment, the recommenders include a news content recommender 261 that produces decision aiding information for members based on the news content. The news content recommender 261 analyzes news content within a specified time interval (e.g., the previous three months) to determine whether members in the connection map are mentioned within the news content. In one embodiment, the news content recommender 261 modifies the decision aiding information of members mentioned in the news content. For example, the news content recommender 261 may increase the recommendation score of a member that is mentioned in a news story about a recent promotion, job title change, reorganization, and so on.

In one embodiment, the news content recommender 261 performs a semantic analysis of news content referencing a member in the connection map and determines whether to modify the decision aiding information of the member based on the content. Content that evidences a favorable opinion of a member may result in an increase in the recommendation score of the member. For example, if the semantic content of the news story indicates that a member has been promoted to a particular position within an enterprise 110, the news content recommender 261 may generate a recommendation score for the member based on relevance of that position to the user. In contrast, content that evidences an unfavorable opinion of a member may result in a decrease in the recommendation score of the member.

The recommenders also include a user endorsement recommender 262 that produces decision aiding information for members based on endorsements made by users of the enterprise intelligence system 150. In one embodiment, the user endorsement recommender 262 clusters similar users, members, and enterprises. Users are clustered using their profile information, such as using their personal information, preferences, educational profile, and employment engagements. In addition, members are clustered using the same information. The clustering can also be done depending on information collected by the data collection module 230. Enterprise clustering is based on the attributes the enterprises possess in general.

The user endorsement recommender 262 uses the behaviors of users within clusters to signify endorsements of particular members and enterprises and/or clusters of members and enterprises. Members and enterprises targeted by users in a cluster are considered “endorsed” and receive higher recommendation scores in recommendations made to other users of the cluster. In one embodiment, based on the view histories of users and the popularity of members within an enterprise, the users may be prompted to explicitly endorse certain members. The user endorsement recommender 262 uses these endorsements to build a training set, for example, by which user preference patterns are learned to train a classifier. The user endorsement recommender 262 uses the classifier to identify members and enterprises to recommend to users as “endorsed.” The user endorsement recommendations change over time as users use the enterprise intelligence system 150.

The recommenders also include a members popularity recommender 263 that produces decision aiding information for members based on the popularity of the members in relation to the users 120 of the enterprise intelligence system 150 and the content sources 140. The members popularity recommender 263 receives the users' member watch lists, and the outputs of the user endorsement recommender 262 and the news content recommender 261. The members popularity recommender 263 calculates decision aiding information for a member as a function of the decision aiding information output by these other recommenders. An embodiment of the members popularity recommender 263 determines a recommendation score for a member using the equation: popularity measure=f (watch lists)+g (user endorsements)+h (news content recommendation) where f, g and h are weighting functions that apply weights to the scores of the other recommenders. The “watch lists” value indicates the number of users who have the given member in their watch lists. The “user endorsements” value indicates the number of endorsements the member received from the cluster of users in which the user for which the recommendation is being prepared belongs. Similarly the “news content recommendation” value indicates the number and the quality of news content received about the given member. The weights of functions f ( ), g ( ) and h ( ) are not fixed and may vary over time.

The recommenders also include a social networking content recommender 264 that produces recommendation scores for members based on social networking activities of the members. The social networking content recommender 264 obtains social network activity information about the user for whom the recommendation is being made and members in the user's watch list, as well as information about other members related to the members in the watch list from the social networks 130. The social networking content recommender 264 analyzes the social networking activities of the user and members to produce decision aiding information for the members. For example, the more closely aligned the members' social networking activities with those of the user, the higher the recommendation scores for the members.

In one embodiment, the social networking content recommender 264 analyzes the social network activities of members to identify any affinity groups on the social networks with which the members are involved. The social networking content recommender 264 also determines the most common affinity groups of users in the same cluster as the user for whom the recommendation is being generated. In one example, the greater the overlap between the affinity groups of a member and the most common affinity groups in the cluster, the higher the recommendation score that the social networking content recommender 264 produces for the member.

In addition, the social networking content recommender 264 may use activities beyond group membership to produce the decision aiding information for a member. The social networking content recommender 264 may use endorsement made by users and members in the social networks 130 to influence the decision aiding information. For example, members having more endorsements receive higher recommendation scores. The social networking content recommender 264 may additionally consider the content of the affinity groups, the nature of the members' participation in the group, and the content posted by the members in the social networks 130 when generating the decision aiding information for a member.

The recommendation generation module 260 may use the outputs of the recommenders to identify one or more specific members with whom a user should connect in order to further the user's goals. Further, the recommendation generation module 260 may analyze the connection map to discern a set of social connections that connect the user to a specific member. For example, assume the user is interested in connecting with the member of an enterprise responsible for making purchasing decisions, and the news recommender 261 and/or other recommenders identify a specific member of the enterprise responsible for purchasing decisions. In this case, the recommendation generation module 260 may identify this specific member as the “best” member, and analyze the connection map to identify a path of social links from the user to the best member.

A recommendation presentation module 270 within the enterprise intelligence system 150 presents the recommendations generated by the recommendation generation module 260 to users. In one embodiment, the recommendation presentation module 270 creates a GUI that includes a visual representation of the connection map for a user. The connection map illustrates the members in the target community specified by the user. The connection map may illustrate the path through the social links in the connection map that connects the user with one or more “best” members recommended by the recommendation generation module 260.

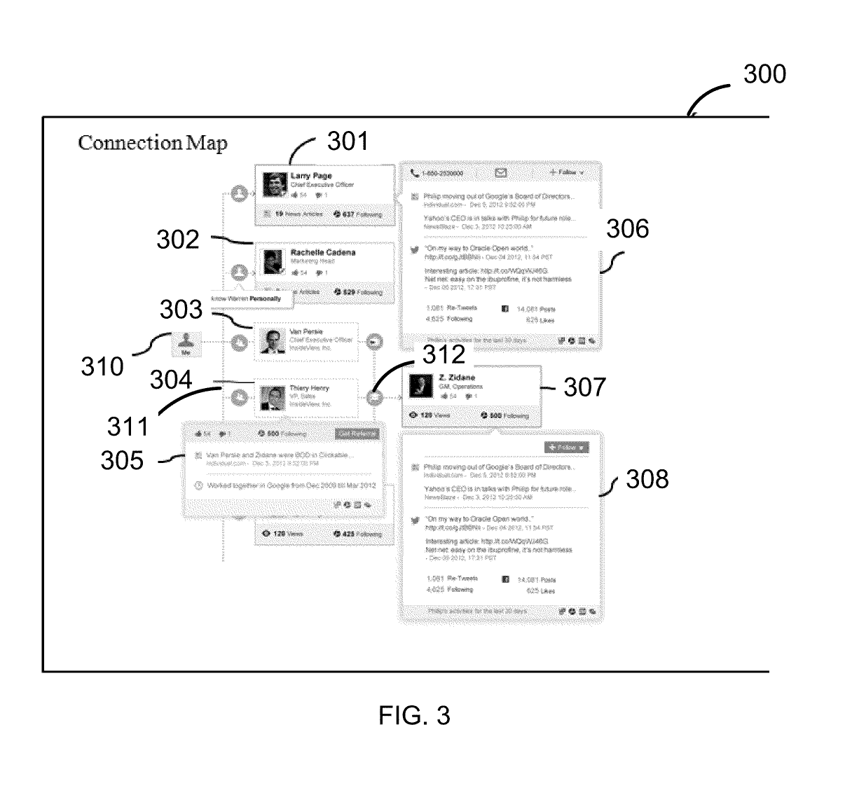

In one embodiment, the members are organized into hierarchies. Each level of the hierarchy represents a degree of separation from the user in the connection map, and within each hierarchy the members are organized based the decision aiding information produced by the recommendation model associated with the user. For example, members receiving higher recommendation scores in the model are ranked ahead of members receiving lower recommendation scores. As there may be many members within a level of the hierarchy, the organization of the members within the hierarchy serves to visually distinguish the more highly-recommended members from other members. An example of a user interface generated by the recommendation presentation module 270 is illustrated in FIG. 3.

In one embodiment, the GUI presented by the recommendation presentation module 270 includes elements allowing the user to navigate the connection map. The user can select an individual member in the connection map and see additional information about that member. The additional information includes information collected from the content sources 140, social networks 130, and enterprises 110 and may include, for example, a picture of the member, information about the member's relationship to an enterprise (e.g., job title), social networking activity of the member, and the like. This information may include news information about the member presented in chronological order.

In addition, the GUI presented by the recommendation presentation module 270 allows the user to alter the recommendations made by the recommendation generation module 260. In one embodiment, the user can use the UI to select different and/or additional recommenders to use for a particular level of the hierarchy. In this instance, the recommendation generation module 260 regenerates the recommendations provided to the recommendation presentation module 270 based on the new selection of recommenders.

An interaction observation module 280 observes and records user interactions with connection maps presented by the recommendation presentation module 270. As mentioned above, these interactions may include navigations of the connection maps, selecting individual members, and selecting particular recommenders. The interaction observation module 280 records these interactions in association with the individual users that conduct the interactions.

In addition, the interaction observation module 280 records timestamps indicating the times and dates at which these interactions occur. The interaction observation module 280 may use the timestamps to determine the types of recommenders preferred by the user during a period of time. In addition, the interaction observation module 280 may use the timestamps to determine how quickly the user performs actions while interacting with the connection map. For example, the interaction observation module 280 may use the timestamps to determine how quickly a user interacts with a member designated as the “best” on a connection map. The interaction observation module 280 monitors the connections statistics usage to determine variations (e.g., rise or fall) in the user's interactions with the connection map with respect to a particular organization, over time, based on the interaction time stamps.

A recommender model update module 290 updates recommendation models associated with users based on the interactions recorded by the interaction observation module 280. The recommender model update module 290 learns the users' recommendation preferences over time, and uses these preferences to modify the models to improve the recommendations for individual users. The recommender model update module 290 is incorporated into the recommendation generation module 260 in some embodiments.

In one embodiment, the recommender model update module 290 modifies the weights in the recommendation models maintained by the recommendation generation module 260 based on the users' observed interactions with the members in the connection maps. For example, if user tends to re-prioritize the recommendations to emphasize a particular recommender, the recommender model update module 290 may increase the weight of that recommender in the user's recommendation model, so that subsequent connection maps incorporate the user's indicated priorities.

In other words, the recommender model update module 290 learns, from the observed user interactions, the patterns of recommenders preferred by the users. The recommender update module 290 then updates the users' recommendation models based on these learned patterns so that future member recommendations generated for and provided to the users may be preferentially guided by the decision aiding information provided by the recommenders preferred by the individual users.

Since a user may interact differently with connection maps of different target communities, the user's recommendation model can be target-community-specific and therefore vary across target communities. For example, for specific target communities that lack reliable news content sources, the user may explicitly or implicitly indicate a preference toward recommenders other than the news content recommender 261 for those specific target communities.

In addition, the recommender model update module 290 may use the timestamps recorded by the interaction observation module 280 to influence the recommendations. The recommender model update module 290 may correlate the user's interactions with external real-world events that involve the user and/or enterprise. For example, the recommender model update module 290 may analyze the content collected from the content sources 140 to determine that a particular event involving an enterprise is occurring (e.g., the enterprise is conducting a trade show or marketing campaign). In this manner, the recommender model update module 290 may learn over time that the user tends to prefer certain recommenders during certain real-world events. These preferences are stored as patterns of recommenders. If the recommender model update module 290 detects that such an event occurs in the future, the recommender model update module 290 may proactively increase the influence of the user's preferred recommenders according to the patterns of recommenders for the duration of the event. Thus, the timestamps are used in combination with the real-world events to enhance the recommendations provided to the user.

Furthermore, the recommender model update module 290 may correlate the user's timestamped interactions with the connection map with recommendations made by the recommendation generation module 260 to enhance the recommendations. In one embodiment, the recommender model update module 290 correlates the length of time before a user interacts with a recommended member with the recommenders used to make the recommendation. If a user interacts with a recommended member quickly, this interaction is treated as a signal that favors the recommenders that produced the recommendation. If the user does not interact with the member, or interacts only after an extended period of time, this behavior is treated as a signal that reflects negatively on the recommenders that produced the recommendation.

In one embodiment, the recommender model update module 290 uses machine learning to update the models maintained by the recommendation generation module 260. The machine learning aspect may use a Hidden Markov Model (HMM) to represent the behaviors of the users and influence the recommendations. Other embodiments may use other machine learning techniques to update the models.

According to one embodiment, the recommender model update module 290 determines the implicit probable social connection of the user with a member of an enterprise with whom the user may not share any first or second degree connections. As an example, if a recommender determines that a certain member of enterprise ‘X’ has expressed positive sentiments toward another member ‘Y,’ then recommender model update module 290 may alert the user that there is a probable connection path to member ‘Y’, via member ‘X’, since the user has direct first or second degree connection with member ‘X’. This nature of probable connection between the user and member ‘Y’ is considered implicit in nature. In general, probable implicit connections may be inferred based on captured sentiments, semantics, or any other information obtained from the social networks 130 or content sources 140.

FIG. 2B is a block diagram illustrating a more detailed view of the connection mapping module 240 of FIG. 2A, according to one embodiment. In this embodiment, the connection mapping module 240 include a watchlist 241. The watchlist 241 identifies the members and/or enterprises in which the user is interested. The contents of the watchlist are specified by the users and in one embodiment a separate watchlist is maintained for each user. The watchlist 241 may include a member watchlist 242 and an enterprise watchlist 243. The member watchlist 242 identifies specific members and/or general characteristics of the members in which a user is interested. Similarly, the enterprise watchlist 243 identifies specific enterprises and/or general characteristics of the enterprises in which the user is interested.

A connection identification module 244 identifies connections between users and the entities (i.e., members or enterprises) in the users' watchlists using the users' connection maps. For example, if a user specifies a particular member of an enterprise in the user's watchlist, the connection identification module 244 identifies connections between the user and the member in the user's connection map.

As mentioned above, the connection map may represent a user's connections as a hierarchy having a set of first degree connections, a set of second degree connections, and so on. A first degree connection search module 245 identifies a set of first degree connections for a user. A higher degree connection search module 246 identifies sets of second and higher degree connections for the user.

To identify a set of first degree connections, the first degree connection search module 245 receives a set of recommendation criteria from the user. These criteria specify the types of recommenders the user desires to use to identify first degree connections. The first degree connection search module 245 uses the specified recommenders to identify attributes in common between the user and members associated with the targeting criteria. For example, if the user specifies that the first degree connection search module 245 use the news content recommender 261, and specifies a particular enterprise in the enterprise watchlist 243, the first degree connection search module 245 compares the user's profile attributes with the attributes of members of the enterprise determined from the news content to identify first degree connections between the users and the members. Thus, the first degree connection search module 245 may from the news content determine that the user and a member of the enterprise studied at the same educational institution, and therefore identify a first degree connection between the user and the member.

In one embodiment, the higher degree connection search module 246 operates in a manner similar to the first degree connection search module 245, except that the former module identifies higher-degree connections to the user. Thus, if the user is connected to a first member in an enterprise, the higher degree connection search module 246 may determine that the first member is connected to a second member of the enterprise. The higher degree connection search module 246 may use the same or different set of recommendation criteria for each degree of connection. In this manner, the connection identification module 244 identifies connections between users and the members or enterprises in the users' watchlists.

FIG. 3 illustrates the GUI showing a connection map 300 generated by the recommendation presentation module 270 according to one embodiment. Other embodiments may include different GUIs and/or different elements within the GUI.

The connection map 300 includes an icon 310 representing the user for which the connection map is generated. In addition, the connection map 300 includes edges 311 connecting the user's icon 310 to a set of icons 301, 302, 303, and 304 representing the user's first degree connections. The first degree connections are displayed in an order corresponding to the decision aiding information produced by the recommendation model for the user. For example, the highest-ranked member recommendation appears at the top of the GUI (e.g., icon 301) and the other member recommendations (e.g., icons 302, 303, and 304) appear below the highest-ranked member icon in descending order of ranking. In addition, an edge 312 connects an icon 304 representing a first degree connection to an icon 307 representing a second degree connection.

In one embodiment, the connection map 300 is interactive and enables a user viewing the GUI to obtain content associated with the members shown in the map. As an example of such an interaction, the user may request additional information about one or more of the members represented in the connection map 300. For example, the user may select an icon for a member using a pointing device in order to request the information. Responsive to the user's request, display windows 305, 306, and 308 provide additional information about the associated members (in this case, members 304, 301, and 307, respectively).

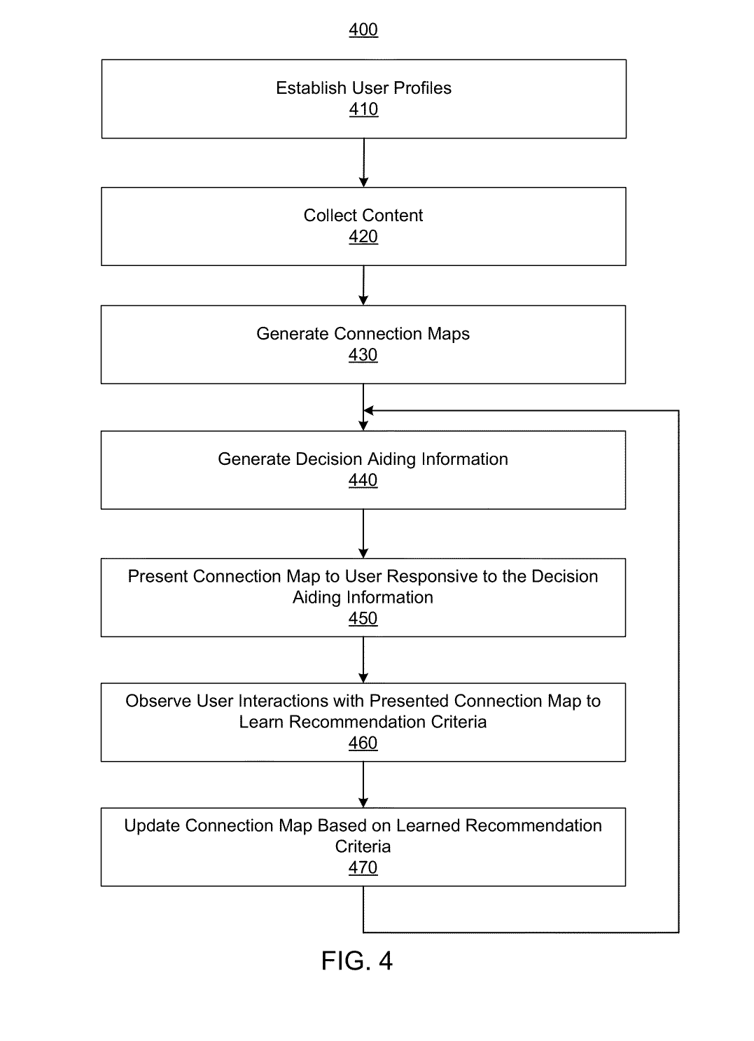

FIG. 4 is a flowchart illustrating steps performed by the enterprise intelligence system 150 according to one embodiment. Embodiments may perform the steps in parallel and/or perform the steps in different orders. Likewise, embodiments may perform different and/or additional steps in other embodiments.

The enterprise intelligence system 150 establishes 410 user profiles for one or more users 120 of the enterprise intelligence system. The user profiles 410 may be established, for example, when the users establish accounts with the enterprise intelligence system 150. The profiles describe attributes of the users. The users 120 may provide the users' login credentials for the social networks 130, and information from the social networks describing the users' social connections may be stored in the users' profiles. In addition, the enterprise intelligence system 150 collects 420 content from content sources 140. This content may include information about enterprises 110 and members of the enterprises. The information includes information about attributes of the enterprises and members.

The enterprise intelligence system 150 generates 430 connection maps describing social connections between users 120 and members of enterprises 110. In some embodiments, the social connections are based on common attributes between the user and the members of the enterprise, where the common attributes are identified responsive to recommendation criteria specified by the user. In one embodiment, a given user 120 provides one or more watchlists 241 identifying the entities (i.e., members and/or enterprises) in which the user is interested. In some embodiments, the Watchlists 241 are built in features of the connection mapping module 240. The user is provided access to and the ability to interact with the connection mapping module 240 to update watchlists 241 to reflect changes in the user's interests. In addition, the user specifies recommendation criteria specifying the types of recommenders the user desires to use to identify the first and higher-order connections. The enterprise intelligence system 150 generates 430 a connection map describing the user's social connections with the members and/or enterprises on the watchlist according to the specified recommendation criteria.

The enterprise intelligence system 150 generates 440 decision aiding information regarding members within the connection map for the user 120. In one embodiment, recommendations for members to be included in the connection map are formed based on the decision aiding information (such as numeric recommendation scores) for the individual members. The decision aiding information is generated using a recommendation model that associates a set of weights with decision aiding information produced by a set of multiple recommenders. The recommendation model may be established based on the user's prior interactions with the connection map.

Then, the enterprise intelligence system 150 presents 450 the connection map to the user 120. In one embodiment, the connection map is presented as a GUI having icons representing the recommended members. The members shown in the GUI are ordered in response to the decision aiding information produced by the recommendation model for the members. The user 120 may interact with the connection map to perform tasks such as re-prioritizing the recommendations and requesting additional information about particular members.

The enterprise intelligence system 150 observes 460 the user interactions with the system and stores the interactions in association with the user. From the observed user interactions, the enterprise intelligence system 150 learns recommendation criteria preferred by the user. The enterprise intelligence system 150 updates 470 the connection map presented to the user based on the learned recommendation criteria. Alternatively, or in addition, the user's recommendation model may also be updated based on the observed user interactions and the learned recommendation criteria. In such embodiments, the updated recommendation models are used to generate subsequent recommendations to the user, as well as to update the connection map to reflect the user's preferences.

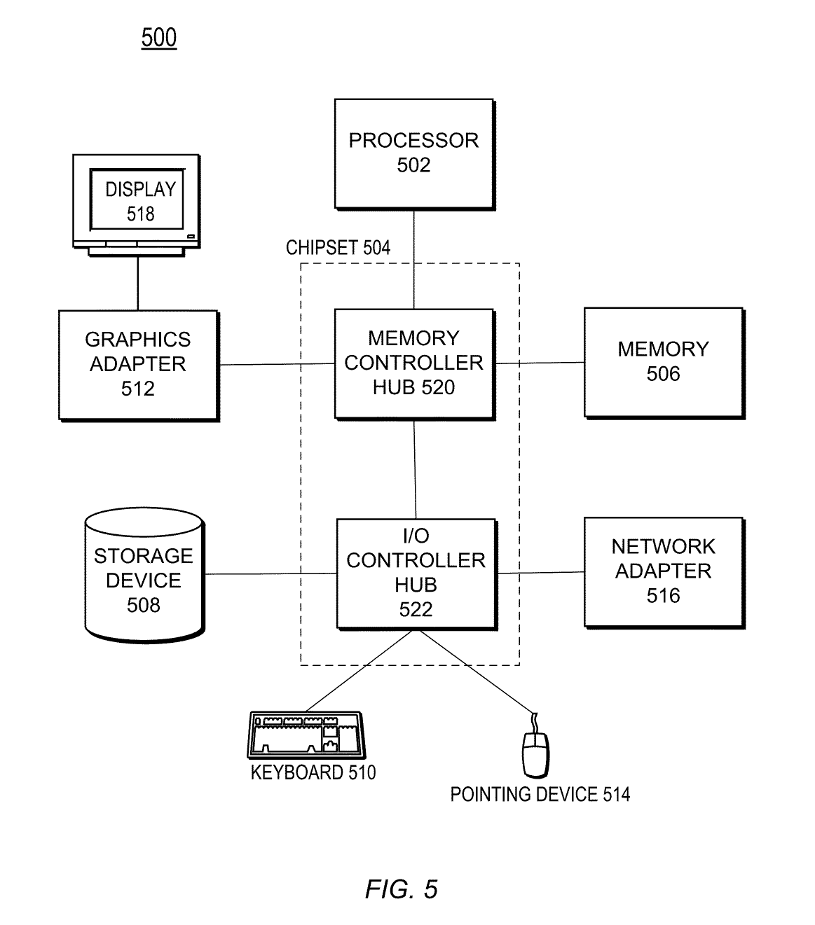

FIG. 5 is a high-level block diagram illustrating physical components of a computer 500 used by one or more of the entities illustrated in FIG. 1 according to one embodiment. Illustrated are at least one processor 502 coupled to a chipset 504. Also coupled to the chipset 504 are a memory 506, a storage device 508, a keyboard 510, a graphics adapter 512, a pointing device 514, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is any non-transitory computer-readable storage medium, such as a hard drive, compact disk read-only memory (CD-ROM), DVD, or a solid-state memory device. The memory 506 holds instructions and data used by the processor 502. The pointing device 514 may be a mouse, track ball, or other type of pointing device, and is used in combination with the keyboard 510 to input data into the computer 500. The graphics adapter 512 displays images and other information on the display 518. The network adapter 516 couples the computer system 500 to a local or wide area network.

As is known in the art, a computer 500 can have different and/or other components than those shown in FIG. 5. In addition, the computer 500 can lack certain illustrated components. In one embodiment, a computer 500 acting as a server may lack a keyboard 510, pointing device 514, graphics adapter 512, and/or display 518. Moreover, the storage device 508 can be local and/or remote from the computer 500 (such as embodied within a storage area network (SAN)).

As is known in the art, the computer 500 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 508, loaded into the memory 506, and executed by the processor 502.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### OTHER CONSIDERATIONS

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer implemented method executed by one or more computing devices for generating a connection map for a user, the method comprising:
receiving a plurality of attributes of the user;
collecting content about a plurality of members of an enterprise from a plurality of content sources, wherein the content specifies a plurality of attributes of the plurality of members of the enterprise;
generating a plurality of social connections between the user and the plurality of members of the enterprise, wherein the plurality of social connections are based on at least one common attribute between the user and the plurality of members of the enterprise;
generating decision aiding information responsive to at least one recommendation criterion preferred by the user in association with the at least one common attribute;
observing a plurality of interactions between the user and the generated connection map to learn at least one recommendation criterion preferred by the user in a time period; and
utilizing the at least one learned recommendation criterion to update the connection map.

2. The method of claim 1, wherein generating the decision aiding information comprises:
displaying the plurality of members of the enterprise in the connection map in an order wherein the order strengthens the at least one common attribute in response to the at least one recommendation criterion preferred by the user; and
updating the connection map with the plurality of members of the enterprise in response to a change in the at least one recommendation criterion preferred by the user in the time period.

3. The method of claim 1, wherein the plurality of attributes of the user comprise at least one of: academic information, career information, personal information, social information, present co-worker information, past co-worker information, reference people information, and alumni information.

4. The method of claim 1, wherein the at least one recommendation criterion specify use of at least one of: a news recommender, a social media recommender, a popularity recommender, an endorsement recommender, and a user similarity recommender.

5. The method of claim 1, wherein the plurality of social connections comprise a plurality of first degree connections based on at least one of: personal information, present co-worker information, past co-worker information, reference people information, and alumni information.

6. The method of claim 1, wherein the plurality of social connections comprise a plurality of second degree connections based on at least one of: personal information, present co-worker information, past co-worker information, reference people information, and alumni information.

7. The method of claim 1, wherein the learning is done by applying at least one machine learning method.

8. The method of claim 1, wherein the enterprise comprises at least one of an organization, a professional group, a social group, a personal group, and a friends group.

9. The method of claim 1, wherein the member of the enterprise comprises at least one of an executive of the enterprise and a friend of the user.

10. A system for generating a connection map for a user, the system comprising:
a computer processor for executing computer program modules; and
a non-transitory computer-readable storage medium for storing computer program modules executable to perform steps comprising:
receiving a plurality of attributes of the user;
collecting content about a plurality of members of an enterprise from a plurality of content sources, wherein the content specifies a plurality of attributes of the plurality of members of the enterprise;
generating a plurality of social connections between the user and the plurality of members of the enterprise, wherein the plurality of social connections are based on at least one common attribute between the user and the plurality of members of the enterprise;
generating decision aiding information responsive to at least one recommendation criterion preferred by the user in association with the at least one common attribute;
observing a plurality of interactions between the user and the generated connection map to learn at least one recommendation criterion preferred by the user in a time period; and
utilizing the at least one learned recommendation criterion to update the connection map.

11. The system of claim 10, wherein generating the decision aiding information comprises:
displaying the plurality of members of the enterprise in the connection map in an order wherein the order strengthens the at least one common attribute in response to the at least one recommendation criterion preferred by the user; and
updating the connection map to the user with the plurality of members of the enterprise in response to a change in the at least one recommendation criterion preferred by the user in the time period.

12. The system of claim 10, wherein the plurality of attributes of the user comprise at least one attribute of: academic information, career information, personal information, social information, present co-worker information, past co-worker information, reference people information, and alumni information.

13. The system of claim 10, wherein the at least one recommendation criterion specify use of at least one of: a news recommender, a social media recommender, a popularity recommender, an endorsement recommender, and a user similarity recommender.

14. The system of claim 10, wherein the plurality of social connections comprise a plurality of first degree connections based on at least one of: personal information, present co-worker information, past co-worker information, reference people information, and alumni information.

15. The system of claim 10, wherein the plurality of social connections comprise a plurality of second degree connections based on at least one of: personal information, present co-worker information, past co-worker information, reference people information, and alumni information.

16. The system of claim 10, wherein the learning is done by applying at least one machine learning method.

17. The system of claim 10, wherein the enterprise comprises at least one of an organization, a professional group, a social group, a personal group, and a friends group.

18. The system of claim 10, wherein the member of the enterprise comprises at least one of an executive of the enterprise and a friend of the user.

19. A non-transitory computer readable medium storing executable computer program code for predicting a probable social connection for a user, the computer program code executable to perform steps comprising:
receiving at least one query from the user regarding at least one member of an enterprise;
receiving at least one preferred recommendation criterion from the user in a time period;
generating a connection map indicating a plurality of social connections between the user and the at least one member of the enterprise, wherein the plurality of social connections comprise a plurality of first degree connections and a plurality of second degree connections wherein the plurality of first degree connections and the plurality of second degree connections are determined responsive to the at least one preferred recommendation criterion;
learning a pattern of the at least one preferred recommendation criterion generated by the user in the time period; and
utilizing the learned pattern of the at least one preferred recommendation criterion to predict the probable social connection of the user with the member of the enterprise.

20. The computer-readable medium of claim 19, wherein predicting the probable social connection comprises determining an implicit social connection, wherein the implicit social connection is independent of the plurality of first degree connections and/or the plurality of second degree connections; wherein the implicit social connection is generated in response to the at least query and/or the pattern of at least one recommendation criterion regarding the member of the enterprise.

21. The computer-readable medium of claim 19, wherein the at least one preferred recommendation criterion specify use of at least one of: a news recommender, a social media recommender, a popularity recommender, an endorsement recommender, and a user similarity recommender.

22. The computer-readable medium of claim 19, wherein the plurality of first degree connections are based on at least one of: personal information, present co-worker information, past co-worker information, reference people information, and alumni information.

23. The computer-readable medium of claim 19, wherein the plurality of second degree connections are based on at least one of: personal information, present co-worker information, past co-worker information, reference people information, and alumni information.

24. The computer-readable medium of claim 19, wherein learning the pattern of the at least one preferred recommendation criterion comprises:
observing a plurality of interactions between the user and the connection map in the time period; and
learning the at least one preferred recommendation criterion preferred by the user in the time period using at least one machine learning method.

25. The computer-readable medium of claim 19, wherein the enterprise comprises at least one of an organization, a professional group, a social group, a personal group, and a friends group.

26. The computer-readable medium of claim 19, wherein the member of the enterprise comprises at least one of an executive of the enterprise and a friend of the user.
